(19) United States
(12) Patent Application Publication
(10) Pub. No.: US 2010/0299650 A1
(43) Pub. Date: Nov. 25, 2010

(54) TEAM AND INDIVIDUAL PERFORMANCE IN THE DEVELOPMENT AND MAINTENANCE OF SOFTWARE

(75) Inventors: Even B. H. Abrahamsen, Kobenhavn 0 (DK); Rajaram S. Acharya, Bangalore (IN); Arjan J.Groaat Baltink, Dalian (CN); Eric H. Brokelberg, Essex Junction, VT (US); David A. Hoffman, Research Triangle Park, NC (US); Oliver Holzwarth, Ehningen (DE); Patrick Howard, New Work, NY (US); Alex Kramer, Somers, NY (US); Lori M. Michelle, Atlanta, GA (US); Rolf Moerman, Amsterdam (NL); Lars Rasmussen, Copenhagen (DK)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/469,390

(22) Filed: May 20, 2009

(51) Int. Cl. G06F 9/44

(52) U.S. Cl. 717/102; 717/103

(57) ABSTRACT

In general, aspects of the present invention provide a system and methods for enhancing, measuring and managing team and individual performance in the development and maintenance of application software. In one embodiment, the present invention comprises a method for enhancing, measuring and managing team and individual performance in the development and maintenance of application software using a Blue Card scoring system where individuals (team members) compare against rubrics set by engagement leaders.

### BACKGROUND OF THE INVENTION

The underlying challenge to software development is time. Time represents the single resource on a project that cannot be created, and once expended, can never be reclaimed. In the highly competitive global markets of today, it is a key determinant in market success.

However, the problem of time persists in most software projects. Numerous studies have shown that the majority of software projects fail to complete on time, resulting in high failure rates and stranded investments. The time challenge has been exacerbated by steadily increasing complexities in the design, development and testing of application software. With most companies dependent on software-intensive systems to render function needed to compete in the marketplace, the time problem is a critical challenge that needs to be resolved.

Therefore, there exists a need for a solution that solves at least one of the deficiencies of the related art.

### SUMMARY OF THE INVENTION

In general, aspects of the present invention provide a system and methods for enhancing, measuring and managing team and individual performance in the development and maintenance of application software.

In one embodiment, the present invention comprises a method for enhancing, measuring and managing team and individual performance in the development and maintenance of application software.

In another embodiment, the present invention comprises a method for enhancing, measuring and managing team, the team having engagement leaders and team members for working on projects, and individual performance being measured for the development and maintenance of application software using Blue Cards, the Blue Cards having Blue Card scores associated with the team members whether they meet predefined schedule, predefined budget or predefined quality requirements, the method comprising: collecting the Blue Card scores from the team members; aggregating the Blue Card scores collected from the team members; determining if the Blue Card scores meet predefined schedule; determining if the Blue Card scores meet predefined budget; determining if the Blue Card scores meet predefined quality requirements; and scoring the team members according to each team's Blue Card scores.

In another embodiment, the present invention comprises a computer program product embodied in a computer readable medium for operating in a system comprising a network I/O, a CPU, and one or more databases, for implementing a method for enhancing, measuring and managing team and individual performance in the development and maintenance of application software, the method comprising: identifying by transparency on work done that may be characterized by a pipeline process, component-based work plans, component deliverables, visibility of the work items in the pipeline by process stage and visibility of work assignments by an individual; identifying by transparency of team and individual performance; identifying by time-based competition; identifying by a fast cycle that may be characterized by high penetration of iterative development to accelerate the delivery of business value; and identifying by a disciplined cycle time management that may be characterized by all work is dimensioned along process defined on discrete intervals of time, declining component costs, and improving cycle time.

In another embodiment, the present invention comprises a system for enhancing, measuring and managing team and individual performance in the development and maintenance of application software, the system comprising a scoring system that scores individuals rather than tasks, wherein the system comprises Blue Cards for the individuals and for the leaders having leader points, the system comprising: a collaborative environment; a social networking tool; a scoring system; an iterative methodology; and communities.

In another embodiment, the present invention comprises a method for deploying a system for enhancing, measuring and managing team and individual performance in the development and maintenance of application software, the method comprising implementing a process, the process comprising, in a system having at least one measuring team and at least one managing team, the system having at least one engagement leader and team members for working on projects, and Blue Cards measuring individual performance in the development and maintenance of application software, the Blue Cards having Blue Card scores associated with whether the team members met schedule, budget or quality requirements, the method comprising implementing a process, the process comprising: collecting the Blue Card scores from the team members; aggregating the Blue Card scores collected from the team members; determining if the Blue Card scores meet predefined schedule; determining if the Blue Card scores meet predefined budget; determining if the Blue Card scores meet predefined quality requirements; and scoring the team members according to each team's Blue Card scores.

Embodiments of the present invention also provide related systems, methods and/or program products.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a data processing system suitable for implementing an embodiment of the present invention.

FIG. 2 shows a network that would work with an embodiment of the present invention.

FIG. 3 illustrates a table showing key design elements and characterizations of the present invention.

FIG. 4 shows a graph illustrating the waterfall and iterative process for reducing risk of the present invention.

FIG. 5 illustrates one method using the Blue Card method of the present invention.

FIG. 6 illustrates a Blue Card method of the present invention.

FIG. 7 illustrates an appeal method of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention.

### DETAILED DESCRIPTION OF THE DRAWINGS

Aspects of the present invention provide a light weight method for driving application software design, development, testing and maintenance activities. It provides a simple and effective technique in a system for synchronizing the activity of small or large development teams, co-located or globally dispersed.

The economics of software development (or “net benefit”) is a function of complexity, process, team and tools. The complexity is defined simply as the size of the system (lines of code or function points are common measures). “Process” references the methods. “Team” is the expertise and skills of the professionals engaged. “Tools” reference technology employed in automating the design, build and testing processes. In other words, time is the principle determinant in the value ultimately derived in a software project. Any of the factors that impede time to value adds cost—and must be rigorously managed to accelerate delivery and avoid delays.

The software industry has made numerous advances to help manage software delivery and improve “time to value”. With an estimated 14 million developers worldwide and a code base of over 800M lines of code, it is reasonable to say that entire industries and economies use software to run their respective businesses. There are enormous “table stakes”, risks and returns involved in the management of application software and delivery. The software industry has driven important advancements in methods such as component based modeling, helping to define architectural principles, rules and methods for defining components of work in the design, coding and testing of applications. Techniques promoting iterative development to accelerate delivery and mitigate risks have been introduced. Important breakthroughs in the new technologies for managing the process of building systems have been realized, including tools that provision highly collaborative environments for enhancing communication and sharing of work among geographically dispersed teams—people or individuals separated by space and time.

The present invention provides a software development method that includes a scoring system. The scoring system scores people or individuals rather than tasks. There are Blue Cards for scoring the people or individuals and also for scoring leaders with leader points. The present invention may comprise a combination of five existing capabilities:
1. a collaborative environment, e.g., the Jazz platform (Jazz is a technology platform for collaborative software delivery provided by IBM®. IBM is a registered trademark of International Business Machines Corp.);
2. social networking, e.g., IBM Lotus® Connections (IBM Lotus Connections is social networking software for business. Lotus is a registered trademark of IBM.);
3. a scoring system;
4. iterative methodology, e.g., Agile (Agile software development refers to a group of software development methodologies that are based on principles of iterative development where requirements evolve through collaboration between self-organizing cross-functional teams); and
5. communities, e.g., global teams.

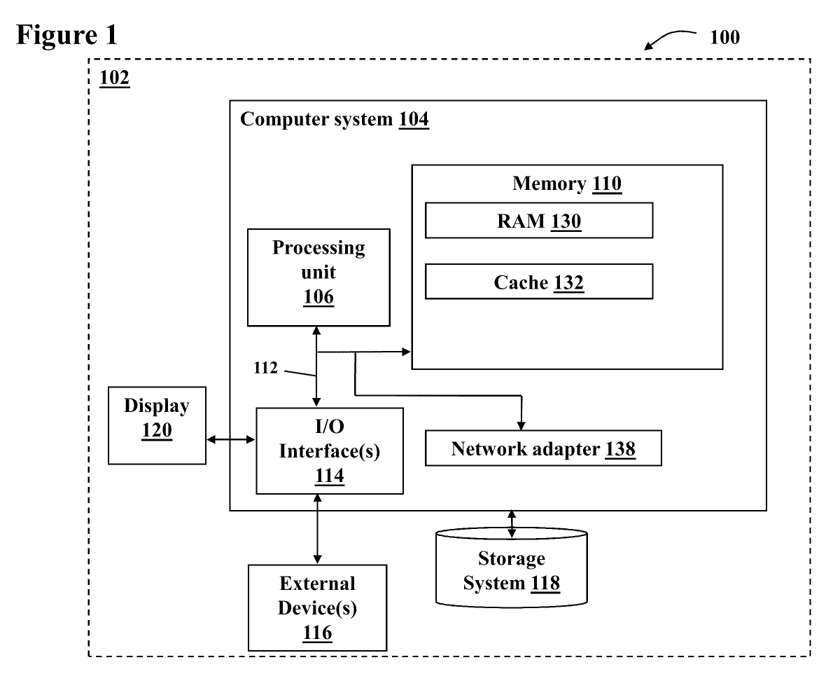

A data processing system 100, such as system 102 shown in FIG. 1 suitable for storing and/or executing program code of the present invention will include a computer system 104 having at least one processor (processing unit 106) coupled directly or indirectly to memory elements (memory 110) through a system bus 112. The memory elements can include local memory (RAM 130) employed during actual execution of the program code, bulk storage (storage 118), and cache memories (cache 132) which provide temporary storage of at least some program code in order to reduce the number of times code must be retrieved from bulk storage 118 during execution. Input/output or I/O devices (external devices 116) (including but not limited to keyboards, displays (display 120), pointing devices, etc.) can be coupled to the system either directly or through intervening I/O controllers (I/O Interface(s) 114).

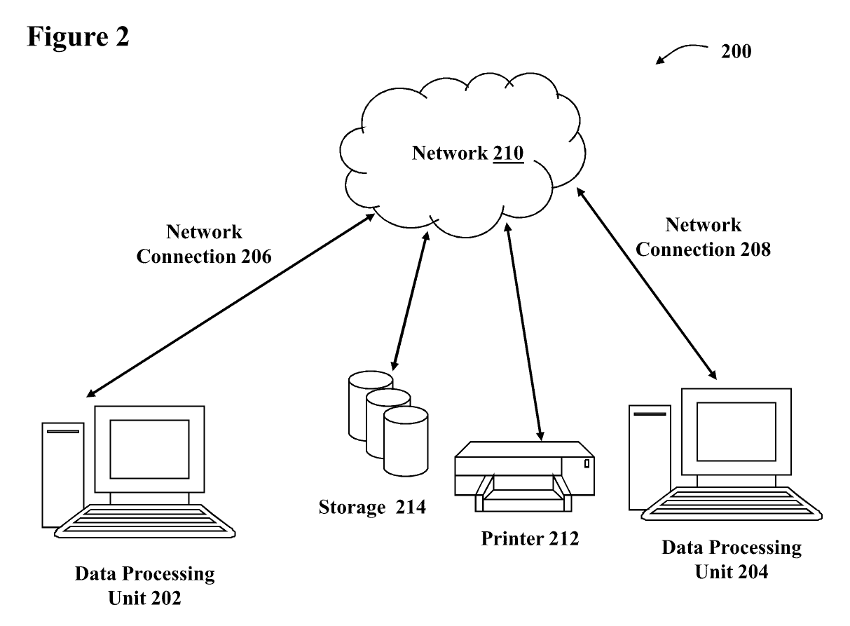

Network adapters (network adapter 138) may also be coupled to the system 200 to enable the data processing system (as shown in FIG. 2, data processing unit 202) to become coupled through network connections (network connection 206, 208) to other data processing systems (data processing unit 202, 204), remote printers (printer 212) and/or storage devices (storage 214) through intervening private and/or public networks (network 210).

The present invention comprises a system and methods for driving application software design, development, testing and maintenance activities. It provides a simple and effective technique for synchronizing the activity of small or large development teams, co-located or globally dispersed.

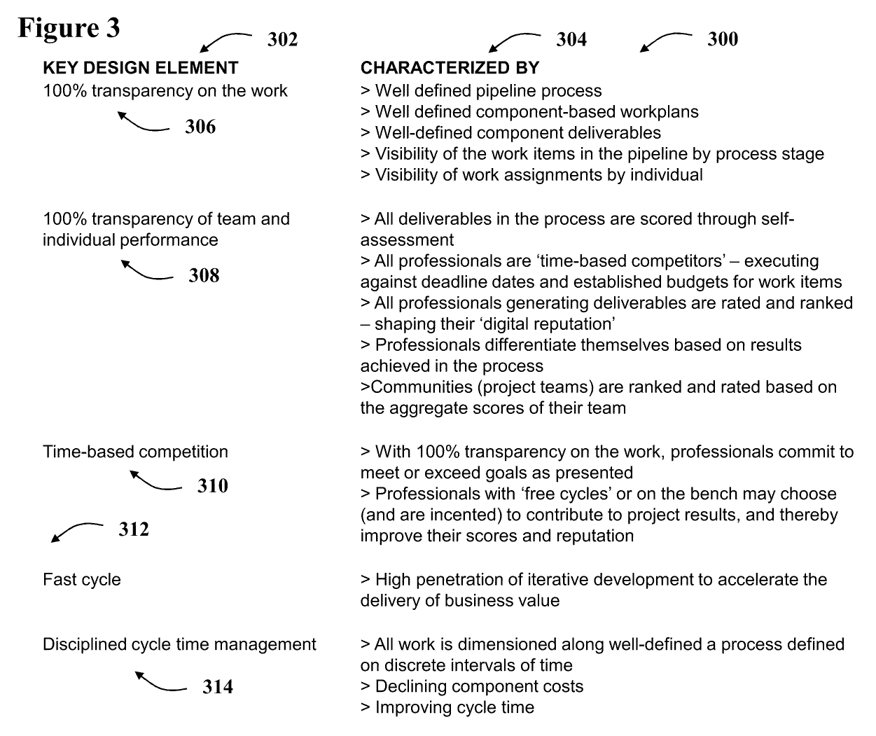

Some of the key design elements are shown in FIG. 3 as 300. In Key Identifiers column 302, key design elements are identified and are characterized in the Characterized By column 304.

One key identifier may be 100% transparency or nearly 100% on the work (or projects or work items) done 306 that may be characterized by a pipeline process, component-based work plans, component deliverables, visibility of the work items in the pipeline by process stage and visibility of work assignments by an individual. “Nearly 100%” may be defined as within 10% of 100%.

Another key identifier may be 100% or nearly 100% transparency of team and individual performance 308. This key identifier may be characterized by all deliverables in the process are scored through self-assessment all professionals or individuals are “time-based competitors”—executing against deadline dates and established budgets for work items, all professionals or individuals generating deliverables or work items are rated and ranked shaping their “digital reputation”, professionals or individuals differentiate themselves based on results achieved in the process, and communities (project teams) are ranked and rated based on the aggregate scores of their team.

Another key identifier may be time-based competition 310. This key identifier 310 may be characterized by 100% or nearly 100% transparency on the work, professionals commit to meet or exceed goals as presented and professionals or individuals with free cycles or on the bench may choose (and are incented) to contribute to project results, and thereby improve their scores and reputation.

Another key identifier may be a fast cycle 312 that may be characterized by high penetration of iterative development to accelerate the delivery of business value.

Another key identifier may be a disciplined cycle time management 314 that may be characterized by all work being dimensioned along a process defined on discrete intervals of time, declining component costs, and improving cycle time.

With the time-based competition methods of the present invention, a number of advantages accrue to a business, project team and professional. It creates the right human motivation—readiness, motivation for reuse and sharing—maintaining their knowledge base of information on tools and embracing best practices. It ensures the right team behaviors—collaboration and sharing and mentoring and coaching. It permits analytics centered on the right key metric—helping a business to identify top developers, designers, testers, and reuse artists—all in the context of time-based performance and delivered results on projects. It provides insights on time impediments—tied to rework and project delivery problems.

It further supplements standard measurement techniques in services, such as utilization. It permits an assessment of leadership on projects, based on the results earned across their team. It also provides an incentive to teams to rapidly resolve problems and identify expeditious solutions to problems—drives people to embrace component development and resolve issues quickly.

The invention provides a foundational notion of time-based competition for application development and integrates a method with a number of key operational, development and management disciplines. As a result, the present invention provides a coherent management framework that can be deployed for a corporation of a services firm, yielding productivity and quality benefits with insights in the management of talent in the enterprise.

The following principles may represent the foundation of time-based performance framework:
staff or project teams may be organized and work may be performed through the staff or project teams;
work is performed as time-based competitions; that is, timeliness and speed are the two principal metrics of performance:
   1. top performers are visible and distinguished; and
   2. the management system is transparent and non-burdensome.

Using a method of the present invention, a company may organize and conduct work associated with application development within worldwide project teams, such as Blue Communities. A Blue Community, comprised of business and technical leaders, architects, analysts, developers and testers, represents the point of planning and execution for new function, enhancements and maintenance. Blue Communities are self-contained and empowered to drive decisions needed to meet quality, cost and schedule objectives for the business.

Blue Communities are generally organized in the same manner as a group of project teams or program. The term Blue Community is used here to denote the need for the Community to be fully vested with “decisioning rights” to drive “time-based performance” competitions.

A Blue Community is generally comprised of a team of professionals, but membership will vary over time-based on requirements and demands of the business. It operates under a set of guidelines for project management, business modeling and application development. Techniques related to open source software development and iterative development processes are deployed where practical. As noted in the chart below, with iterative development (reinforced by time-based competition) risk is reduced.

The principles of open source development are foundational to the performance of a Blue Community. With Jazz Rational Team Concert, key elements of an open source community can be adopted for application development while ensuring a high degree of security and data privacy. These elements include transparency on a work items pipeline, transparency on work assignments, process governance (consistent with Agile techniques), collaboration and continuous development. With transparency on work, horizontal decisions accelerate in the Community. Although Jazz is not required, this technology is recommended for use with this method to ensure a high degree of transparency and collaboration.

Time-based competition is a business method that emphasizes time as the critical performance measurement criterion. Time-based competition is an implementation of that method such that each unit of work performed represents a competition against the clock or against a standard measure of time. Every individual becomes a time-based competitor whose personal profile carries a Blue Card (a score card of work performed). A project is planned based on the number of components that needs to be developed and delivered for an application. Components are partitioned as discrete units of work, generally ranging from 16 to 60 hours of work. Each component is assigned to an individual, and the results of the work are scored based on specific criteria related to quality, cycle time, speed and reuse. The results of their performance on the deliverable are captured on their Blue Card.

All members of a Blue Community are time-based competitors. In a time-based environment, the professionals are able to differentiate themselves based on their individual contributions across their assignments against set objectives. (Note that “competition” and “competitors” do not imply any competition other that of the individual against time—not competition with others.)

The top performers are identified based on the relative rating of their aggregate Blue Card results, captured over prior deliverables or work items (such as 30) or time, such as six months of work. The professionals or individuals may differentiate their performance through collaboration, reuse, speed of execution and quality execution. They are scored based upon whether they meet or beat deadline dates. Time-based competition becomes a sea of change for the delivery organization which is a capability not easily replicated by competitors.

With Blue Cards, the performance of engagement leaders, architects and whole communities can be rated as well, based on the aggregate scores of their team members, permitting top leadership to differentiate their performance as well.

Top talent may promote their respective Blue Cards for view by the worldwide community, providing recognition among all professionals. With transparency on performance, horizontal decisions accelerate even faster.

The management system is simplified. Standard project status reporting would be deployed, but with the focus on deliverables and work items (components), a simpler view of status, progress and achievements can be driven across the team.

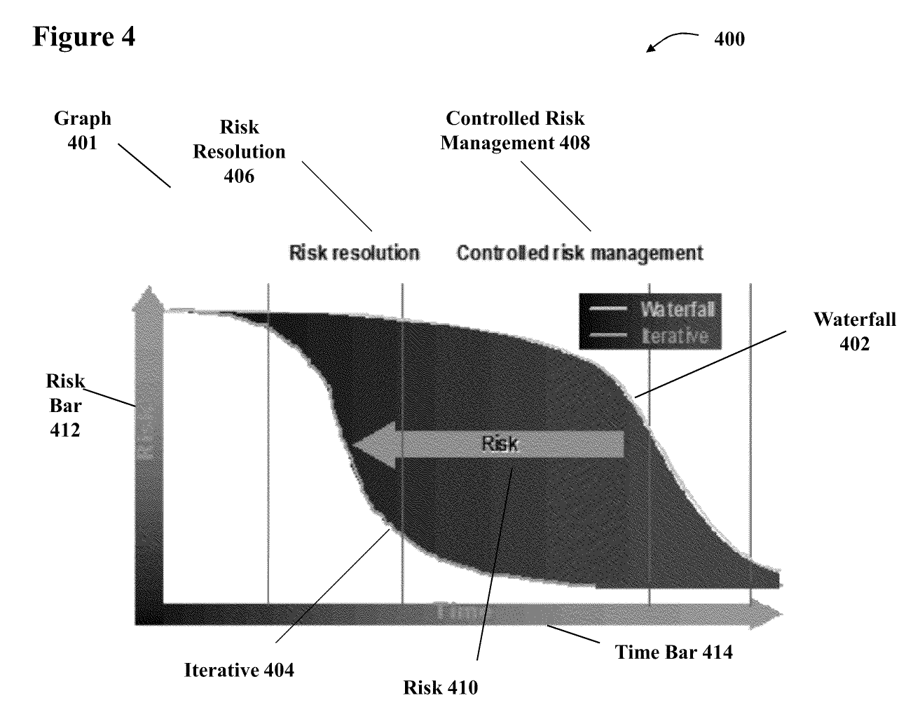

A specification for a cycle of work is provided in a detailed and common format consistent with development methodology (such as IBM's Global Services Method or OPAL (IBM's On Demand Process Asset Library) which in itself is an element of the IBM Global Solution Delivery Framework or IGSDF. For development methodology, the IBM Unified Method (or the “Method”) can be used and executed in an iterative fashion (using a technique like Agile software development Agile software development refers to a group of software development methodologies based on iterative development, where requirements and solutions evolve through collaboration between self-organizing cross-functional teams). This is shown in FIG. 4 in graph 401 having a horizontal time bar 414 and a vertical risk bar 412. Graph 401 further illustrates risk resolution 406 and controlled risk management 408. Risk 410 reduction is shown through this process. While iterative development 404 is recommended in the use of this method—it is not mandatory. A waterfall methodology 402 can also be used with the time-based competition invention.

Specifications may be made available to the project community (core and extended team members) in a forum or team room. The specification is managed by a project or engagement leader in the work items list, specifying appropriate budgets, time parameters and special requirements. The work items list may be visible to all members of the community, including assignments, status, risk and the deliverables.

The consistency of the specifications helps professionals or individuals to quickly interpret the requirements for work. If a work item is ambiguous or complex, an opportunity may be provided for a professional to clarify requirements through collaborative networking subject matter experts (SMEs) and senior leaders are able to monitor questions and issues and provide direction and insights. Once a professional or individual engages a piece of work or work item, through assignment or selection, he is measured on his execution against posted metrics including requirements for the work product, quality of the result, speed of delivery and cycle time of the work activity.

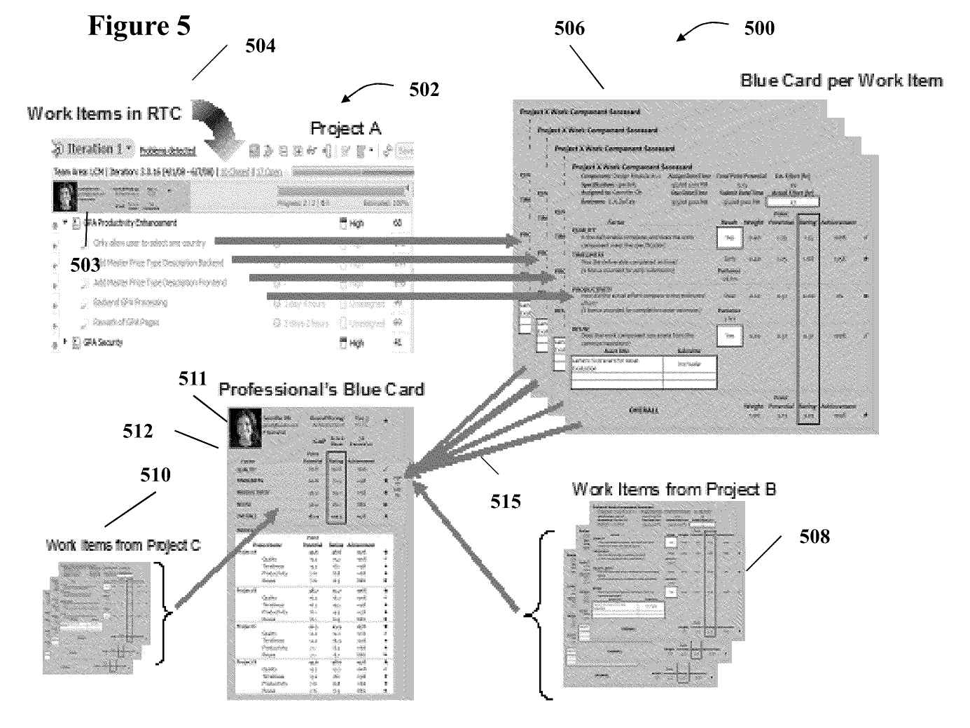

The time-based competition format 500, such as shown in FIG. 5, focuses attention of the professionals on a very critical dimension of business. For example, the execution model for a globally integrated operation requires disciplined cycle time management of a complex array of activities involved in the management of software projects. The project plan requires precision on the interlocking elements of work. Work items such as work items in RTC 504 from Project A 502 must be well-defined based on standards. The work must be delivered in a lockstep schedule to Blue Card per work item 506. As schedules shift and delivery cycles extend, a multiplicative impact on costs may be experienced. Furthermore, an advantage in market position may be eroded or lost. As schedules are met, and cycle times for delivery compressed, competitive advantage is gained. The rules of engagement are straightforward. An estimate of work (e.g., 40 work hours) and end date/time (e.g., 5 p.m. EDT, one week hence) are specified by the project manager/architect 503 for the deliverable. In any given project, the project manager/architect may open a work item to the core team. The work items 515 may be assigned to core team members or remain open and available for any professional to pick based on time availability. Beyond the core team 511, there is the extended team (i.e., professionals on other assignments or in between assignments). An unassigned work item 515 may be picked up by a core or extended team member 511. The deliverable or work item submitted by a professional 511 is rated against standard, with scores assigned respectively and captured on his Blue Card 512. Any qualified extended team member may “check out” the module (deliverable or work item) competing against the clock to complete the deliverable and thereby improve his/her scorecard such as shown as work items from Project B 508 and work items from Project C 510.

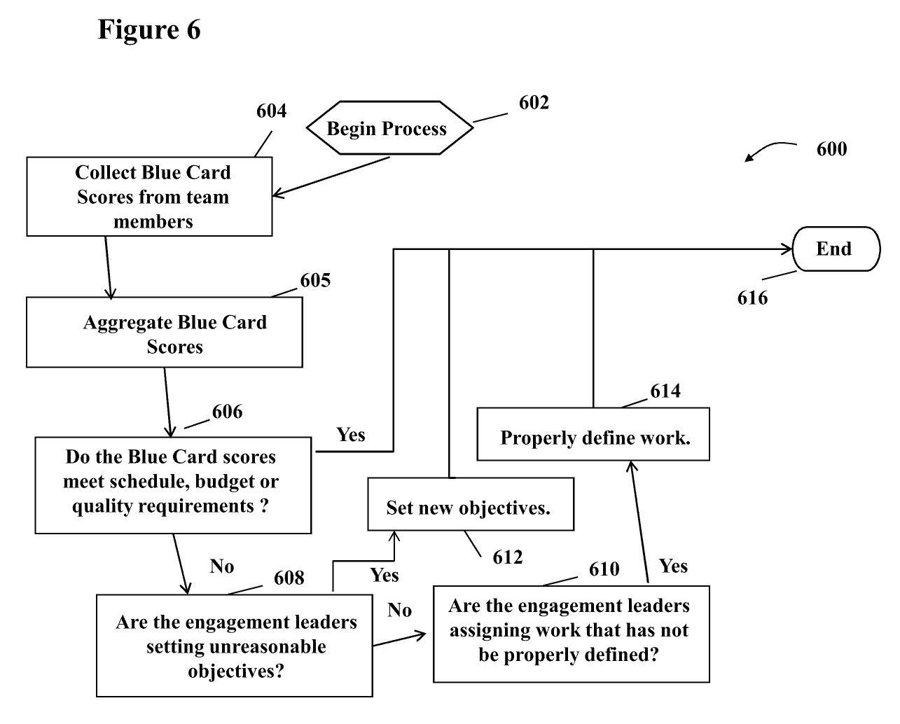

FIG. 6 shows the process 600 in greater detail that begins at 602 and continues to 604 where Blue Card scores are aggregated at 605 and at 606 where it is determined whether the Blue Card scores meet schedule, budget or quality requirements. If so, the process 600 ends at 616. If not, at 608, it is determined whether the engagement leaders are setting unreasonable objectives. If so, new objectives are set at 612 and the process ends at 616. If the engagement leaders are not setting unreasonable objectives, at 610, it is determined whether the engagement or project leaders are assigning work that has not been properly defined and, if the engagement leaders are assigning work that has not been properly defined, at 614, the engagement leaders must properly define assigned work that has been properly defined and the process ends at 616.

The dynamic of the time-based competition model is experienced in two ways. Before a professional engages, he evaluates the component of work or work item to ensure that the requirements are clear, time schedule realistic and support enabled. This is shown in process 700 that begins at 702 and continues to 704 where it is determined by the professional whether the requirements of the component of work are clear, time schedule realistic and support enabled and, if so, the process ends at 708.

The professional may appeal the assignment if issues (such as lack of clarity, unrealistic time schedule and lack of support) are identified, precluding competitive performance in the execution of the assigned work. An appeal may be launched, for example, if the component specification is poorly organized, or lacks leverage otherwise required through reuse in order to meet specified time frames. This is shown at step 706, where it is determined by the professional whether the requirements of the component of work are clear, time schedule realistic and support enabled. An appeal permits the lead designer or engagement leader to remediate issues if valid at 708, 710. The work also may be reassigned to another professional if appropriate at 712. In any instance, once the professional engages on a work activity, the time-based competition starts.

The second dynamic is experienced through recognition gained by a professional through the process. Architects and senior IT professionals build their reputation through well structured designs. Developers build their reputations through delivery of quality work products in a timely fashion. This dynamic is addressed in greater detail below.

Time is the principal metric on which the deliverable is measured. A timely submission of a complete deliverable is required to score high in the process. In order to ensure fairness in the process, no exceptions are granted on deadline dates for any reason once a professional engages in the process.

It is important to note that this zero-tolerance rule applies to the measurement of cycle time (due date) and to the speed metric (hours-of-work estimate) as well. Although the schedule may change, and hours can be misestimated for a variety of reasons, the original date and time estimate is maintained. Variations may become new work items in the queue, but the original targets are never changed.

This rule provides for fairness across all projects, all teams and all project managers (PMs), while ultimately providing a window of visibility to the team's management and skill in creating work items, helping to manage the flow of work and estimating completion requirements and work efforts.

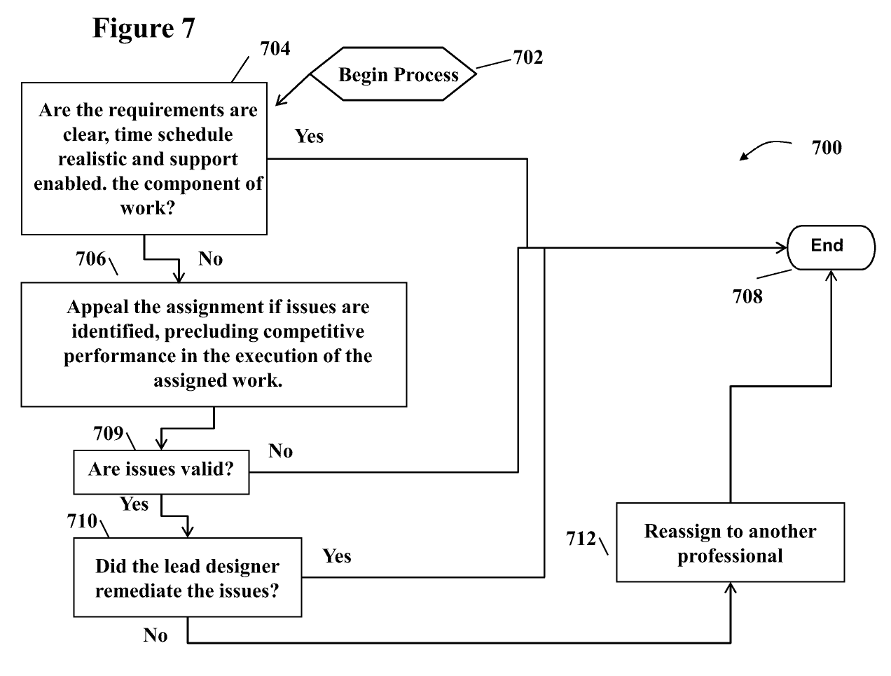

A professional completes and submits his self assessment, recorded on his Blue Card, for each deliverable (which is shown at FIG. 5 (e.g., 502, 506)). The rubric for the Blue Card may include four primary elements: objective, simple, fair and non-intensive as shown in Table 1 below. The self-assessment may be reviewed by the professional's team lead or project management (511) on the engagement, and updated or approved. An employee may appeal the decision made by a supervisor on the self assessment. (See FIG. 7.)

TABLE 1

| | |
|---|---|
| Objective: | The metrics are largely quantitative and do not |
| | require or support subjective evaluation |
| Simple: | Easy to understand, easy to measure and common |
| | to all project work |
| Fair: | The metric is highly likely to be self-leveling over |
| | time and fair to a statistically acceptable degree |
| Non-intensive: | Management function, reporting, reviews, etc. are |
| | lightweight, non-intensive or time consuming. |
| | Activities related to scoring and Blue Cards are |
| | automated byproducts of the process or, at most, |
| | activities measured in minutes, not hours |

Work products go through an initial screening using set criteria to ensure completeness and conformity to standards. This screening ensures that the basic requirements of the deliverable are met, and ensures that all requirements for the submission itself are correct (i.e., ensures that the submission includes everything required to be included and is packaged appropriately). This is a basic quality check and the quality score generated during this screening ensures that a submission meets a minimum quality requirement for the deliverable. This screening process is intended to be non-subjective. If a deliverable does not pass this screen, the professional effectively loses the competition against time and is directed to remedy the problem. The time engaged in remedial work, while part of utilization, does not count towards Blue Card score accumulation and is therefore, in a very real sense, a scoring penalty.

Once a deliverable passes the initial screen on quality, it is scored for the additional metrics.

A score for the deliverable is captured on the professional's Blue Card. The accumulation of Blue Card scores over an amount of work items or deliverables (such as 30 deliverables) or a period of time (such as 6 months), on a rolling basis, represents the basis for rating professionals. If a professional has achieved a maximum score on all deliverables (e.g., 7 points) and had assignments that spanned over a period of time (e.g., every calendar of a 6 month period), he could reach the maximum score of 1260 (7×180 days). This is unlikely, although it is not unlikely for top professionals to score very high by beating deadline dates on a series of assignments through reuse, collaboration, innovation and hard work.

The Blue Card of project managers, team leaders and architects are aggregated from Blue Card scores of professionals working for them on assignment. This represents an important dynamic in the operation of Blue Communities. On one hand, project managers and architects with teams that consistently outstrip performance criteria in time-based competitions shows that the engagement leaders are not properly planning their projects, effectively inflating costs and schedules of a project. On the other hand, project managers and architects who have teams that fail to meet schedule, budget or quality requirements may be setting unreasonable objectives, or assigning work that has not been properly defined. Project managers and architects with teams that are meeting their goals—and demonstrating continued improvements in reuse and cycle time management—depict the type of time-based leadership required in a globally integrated enterprise.

With this method, all professionals conducting work in a Blue Community are time-based competitors. Each professional holds a Blue Card that captures his contribution to the business along the fundamental elements of quality, cycle time, speed and reuse on his deliverables. Each work item will carry its score and competition details into the overall project Blue Card. The project scoring is effectively the byproduct of a deliverable review, ensuring that quality management practices are built in and integral to the process. In addition to the aggregate project score, Blue Cards for a professional are aggregated for a number of events (such as the past 30 events) or period of time (such as 6 months) to rate performance as a time-based competitor.

A professional is permitted to make his Blue Card visible to the community when he achieves certain threshold limits in his performance. This level of community recognition underscores the effectiveness of the professional in driving results on his engagements. Transparency to performance is a key dimension of this method: the framework within which an employee can distinguish him/herself within the community.

The Blue Card provides input to the employee's review process and incentive process. The legacy measurement process for a company based on periodic, project reviews and annual assessments would remain, but be supplemented in a meaningful, quantitative fashion by the Blue Card. It becomes important to the employee, updated constantly through time competition on component work items and, perhaps more importantly, in the employee's control. He can find work in the open source style Blue Community that fits his skills and compete against time to win and add value to his Blue Card. Bench time (or free cycle time) becomes the employee's available time to add value to the Blue Card by finding and completing work which would otherwise await assignment through the normal PM/resource management process.

Through this process, a traditional measurement like utilization becomes balanced with productivity. In many service firm environments, utilization is the principal quantitative measure of employee performance, balanced by various subjective measures through project input. Utilization alone can be a disincentive to productivity and component re-use. And, in the commoditized labor environment of the global economy, does not serve well to measure value to the customer. By adding the Blue Cards which add metrics of quality, effectiveness, reuse and efficiency utilization takes on new value.

The professional's Blue Card is comprised of a set of metrics that are used consistently on every work item using the same rubrics to ensure comparability and fairness. The metrics chosen have certain characteristics fundamental to the invention.

TABLE 2
Rubrics: Metric definitions

| | |
|---|---|
| Quality | The completeness of the work product submitted |
| | based on compliance with the prescribed set of |
| | artifacts for the deliverable. This is a binary |
| | measurement indicating that the work item as |
| | submitted meets the basic criteria for acceptability |
| | defined in the work item profile. Note that this metric |
| | is different from the others in that it represents the |
| | threshold for acceptance. A work item submitted as |
| | complete, which does not pass this threshold test of |
| | acceptability receives no further score on any of the |
| | subsequent metrics and is returned to the developer |
| | for rework. |
| Cycle Time | The calendar date submitted as complete versus the |
| | original date set as required for completion. |
| Reuse | The use of an item from, or contribution of an item to |
| | an asset repository. An item in this context is any |
| | reusable module of work acceptable to the |
| | repository based on rules of the firm. |
| Speed | The actual effort to complete a deliverable |
| | compared with the original budget in hours. Actual |
| | effort is equivalent to claimed hours for this piece of |
| | work. |

A sample rubrics (Table 3) for the points earned by a professional follows. The rubrics and points allotted may be modified based on the strategy and focus of the organization.

TABLE 3

| Metric | Summary Description | Miss | Meet | Beat |
|---|---|---|---|---|
| Quality | completeness of the work | 0 | 1 | |
| | product submitted | | | |
| Cycle Time | date submitted as | 0 | 1 | 2 |
| | complete versus the | | | |
| | original date | | | |
| Reuse | use of an item or | 0 | 1 | 2 |
| | contribution of an item from | | | |
| | the repository | | | |
| Speed | hours to complete | 0 | 1 | 2 |
| | compared with the original | | | |
| | budget | | | |
| Multiplier | Intensity measure - | | | |
| | scheduled days of work | | | |
| Reliability | Reliability: Percent of last | | | |
| | 30 Work items with score | | | |
| | >1 | | | |

Note that in addition to the 4 base metrics, a score is computed using the multiplier, which is the number of 8 hour work days. This can be 8.5, 9 or any other policy-driven definition of the standard work day allotted for the work item. This measure addresses complexity, difficulty and intensity of the work item to the extent that a larger piece of work (e.g., it may require more days) will typically be more difficult than a short one. In some respects, assignments of longer duration provide professionals with greater opportunity to beat rather than meet cycle time, reuse and speed factors. On the other hand, longer duration assignments have greater complexity and risk than short duration assignments. It is anticipated that the mix of assignment will self-calibrate and provide a reasonable measure of performance on work over a rolling time period (such as 6 months) basis. The reuse metric can be binary “0” or “1”.

A reliability index is also computed for all professionals. It represents a percentage of a number of work items (such as last 30 work items) submitted with a positive score greater than 1. This measures the reliability of the individual in completing work that has been assigned (or signed up for).

It should be understood that the present invention is typically computer-implemented via hardware and/or software. As such, client systems and/or servers will include computerized components as known in the art. Such components typically include (among others), a processing unit, a memory, a bus, input/output (I/O) interfaces, external devices, etc. It should also be understood that although the present invention provides methods for enhancing, measuring and managing team and individual performance in the development and maintenance of application software.

While shown and described herein as a system and method for enhancing, measuring and managing team and individual performance in the development and maintenance of application software, it is understood that the invention further provides various alternative embodiments. The computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a computer-implemented method for enhancing, measuring and managing team and individual performance in the development and maintenance of application software. In this case, a computerized infrastructure can be provided and one or more systems for performing the process steps of the invention can be obtained (e.g., created, purchased, used, modified, etc.) and deployed to the computerized infrastructure. To this extent, the deployment of a system can comprise one or more of (1) installing program code on a computing device, such as computer system from a computer-readable medium; (2) adding one or more computing devices to the computer infrastructure; and (3) incorporating and/or modifying one or more existing systems of the computer infrastructure to enable the computerized infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing a program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for enhancing, measuring and managing team and individual performance in the development and maintenance of application software, the method comprising identifying key elements, and identifying characteristics associated with the key elements.

2. The method as defined in claim 1 further comprising identifying a key element of 100% transparency on work or of nearly 100% transparency on work, identifying at least one characteristic being associated with the key element of 100% transparency on work or of nearly 100% transparency on work, the method further comprising characterizing the key element 100% transparency on work or nearly 100% transparency of the work with characteristics associated with the 100% transparency on work or the nearly 100% transparency on work.

3. The method as defined in claim 1 further comprising identifying a key element of 100% transparency on work or of nearly 100% transparency on work, identifying at least one characteristic being associated with the key element of 100% transparency on work or of nearly 100% transparency on work, the method further comprising characterizing the key element 100% transparency on work or nearly 100% transparency of the work with characteristics associated with the 100% transparency on work or the nearly 100% transparency on work.
The method as defined in claim 1 further comprising identifying a key element of 100% transparency on work or of nearly 100% transparency on work, identifying at least one characteristic being associated with the key element of 100% transparency on work or of nearly 100% transparency on work, the method further comprising characterizing the key element 100% transparency on work or nearly 100% transparency of the work with characteristics associated with the 100% transparency on work or the nearly 100% transparency on work.

4. The method as defined in claim 1 further comprising identifying a key element of 100% transparency on work or of nearly 100% transparency on work, identifying at least one characteristic being associated with the key element of 100% transparency on work or of nearly 100% transparency on work, the method further comprising characterizing the key element 100% transparency on work or nearly 100% transparency of the work with characteristics associated with the 100% transparency on work or the nearly 100% transparency on work.

5. The method as in claim 1 further comprising identifying a key element of t cycle, identifying at least one characteristic being associated with the key element of fast cycle and further comprising characterizing the key element of fast cycle based upon the at least one characteristic associated with the key element of fast cycle.

6. The method as defined in claim 1 further comprising identifying a key element of disciplined cycle time management, identifying at least one characteristic being associated with the key element of disciplined cycle time management and further comprising characterizing the key element of disciplined cycle time management based upon the at least one characteristic associated with the key element of disciplined cycle time management.

7. A method for enhancing, measuring and managing team, having engagement leaders and team members for working on projects, and individual performance in the development and maintenance of application software using Blue Cards, the Blue Cards having Blue Card scores associated with the team members met schedule, budget or quality requirements, the method comprising
collecting the Blue Card scores from the team members;
aggregating the Blue Card scores collected from the team members;
determining if the Blue Card scores meet schedule;
determining if the Blue Card scores meet budget;
determining if the Blue Card scores meet quality requirements; and
scoring the team members according to each team' Blue Card scores.

8. The method as defined in claim 7 further comprising determining whether the engagement leaders are setting unreasonable goals and, if so, the method further comprising the engagement leaders setting reasonable goals.

9. The method as defined in claim 7 further comprising determining whether the engagement leaders have properly defined the assigned work and, if the engagement leaders have not properly defined the assigned work, the method further comprising properly defining the assigned work.

10. A computer program product embodied in a computer readable medium for operating in a system comprising a network I/O, a CPU, and one or more databases, for implementing a method for enhancing, measuring and managing team and individual performance in the development and maintenance of application software, the method comprising:
identifying by transparency on the work done that may be characterized by a pipeline process, component-based work plans, component deliverables, visibility of the work items in the pipeline by process stage and visibility of work assignments by an individual;
identifying by transparency of team and individual performance;
identifying by time-based competition;
identifying by a fast cycle that may be characterized by high penetration of iterative development to accelerate the delivery of business value; and
identifying by a cycle time management that may be characterized by all work is dimensioned along process defined on discrete intervals of time, declining component costs, and improving cycle time.

13. A system for enhancing, measuring and managing team and individual performance in the development and maintenance of application software, the system comprising a scoring system that scores individuals rather than tasks, wherein the system comprises Blue Cards for the individuals and leader points for the engagement leaders, the system comprises:
a collaborative environment;
a social networking tool;
a scoring system;
an iterative methodology; and
communities.

14. A method for deploying a system for enhancing, measuring and managing team and individual performance in the development and maintenance of application software, the method comprising implementing a process, the process comprising, in a system having at least one measuring team and at least one managing team, each having at least one engagement leader and team members for working on projects, and individual performance in the development and maintenance of application software using Blue Cards, the Blue Cards having Blue Card scores associated with whether the team members meet schedule, budget or quality requirements, the method comprising implementing a process, the process comprising:
collecting the Blue Card scores from the team members;
aggregating the Blue Card scores collected from the team members;
determining if the Blue Card scores meet schedule;
determining if the Blue Card scores meet budget;
determining if the Blue Card scores meet quality requirements; and
scoring the team members according to each team's Blue Card scores.

15. The method as defined in claim 14 wherein the process further comprises determining whether the at least one engagement leader is setting unreasonable goals and, if so, the method further comprising the at least one engagement leader setting reasonable goals.

16. The method as defined in claim 14 further comprising determining whether the at least one engagement leader have properly defined the assigned work and, if the at least one engagement leader has not properly defined the assigned work, the method further comprising the at least one engagement leader properly defining the work.

17. The method as defined in claim 14, the collecting of the Blue Card scores from the team members comprising:
aggregating the Blue Card scores collected from the team members;
determining if the Blue Card scores meet schedule;
determining if the Blue Card scores meet budget;
determining if the Blue Card scores meet quality requirements; and
scoring the team members according to each team' Blue Card scores.

18. The method as defined in claim 17 further comprising determining whether the engagement leaders are setting unreasonable goals and, if so, the method further comprising the engagement leaders setting reasonable goals.

19. The method as defined in claim 17 further comprising determining whether the engagement leaders have properly defined the assigned work and, if the engagement leaders have not properly defined the assigned work, the method further comprising the engagement leaders properly defining the assigned work.

20. A computer program product embodied in a computer readable medium for operating in a system comprising a network I/O, a CPU, and one or more databases, for implementing a method for enhancing, measuring and managing team and individual performance in the development and maintenance of application software, the method comprising:
identifying by transparency on the work done that may be characterized by a pipeline process, component-based work plans, component deliverables, visibility of the work items in the pipeline by process stage and visibility of work assignments by an individual;
identifying by transparency of team and individual performance;
identifying by time-based competition;
identifying by a fast cycle that may be characterized by high penetration of iterative development to accelerate the delivery of business value; and
identifying by a cycle time management that may be characterized by all work is dimensioned along process defined on discrete intervals of time, declining component costs, and improving cycle time.
